(19) United States
(12) Patent Application Publication
(10) Pub. No.: US 2011/0087476 A1
(43) Pub. Date: Apr. 14, 2011

(54) METHOD AND APPARATUS FOR CONFIGURING OIL AND/OR GAS PRODUCTION SYSTEM

(76) Inventors: Patrick James Calvert, York (GB); Richard Geoffrey Heddle, Surrey (GB)

(21) Appl. No.: 12/737,152

(22) PCT Filed: Jun. 11, 2009
(86) PCT No.: PCT/GB2009/001477

§ 371 Date: Dec. 13, 2010

(30) Foreign Application Priority Data
Jun. 16, 2008 (EP) 08252065.1
Sep. 3, 2008 (EP) 08252920.7

(51) Int. Cl. G06G 7/48

(52) U.S. Cl. 703/10

(57) ABSTRACT

Embodiments of the invention identify a plurality of operating points for oil and/or gas producing systems, each operating point being characterised by a set of operating parameters which can be used to control components of the actual oil and/or gas producing system. These generated operating points may be collectively presented in a graphical manner to an operator of the oil and/or gas producing system, who can systemically configure the components of the oil and/or gas producing system to move, in an informal manner, through a path of operating points in order to reach what appears from the generated operating point data to be an optimal operating region. The oil and/or gas producing system may also be referred to as a hydrocarbon producing system.

### FIELD OF THE INVENTION

The present invention relates to a method and system for identifying operating points for an oil and/or gas producing system and is particularly, but not exclusively suitable for identifying operating points for extracting fluid from an oil or gas reservoir.

### BACKGROUND OF THE INVENTION

Conventionally, optimization algorithms have been extensively applied within the oil and gas sector to deduce an optimum operating point of an oil and gas system, which is to say the configuration of components from the sand face to the export pipeline that constitute the oil and gas installation and control the recovery of oil and gas from an oil or gas reservoir. Typically, a model of the process is created and an optimization algorithm is coupled with the model to deduce the optimum simulated operating point subject to a set of operating constraints. In all cases, an operating point is deduced from the optimization run.

Such a known approach is described in international patent application having publication number WO2004/046503, which describes an optimisation method that identifies an operating point from one or a combination of models relating to the reservoir, well network and an oil and gas processing plant. This approach provides benefits in the sense that the various models can be coupled together in a flexible manner, but it suffers from the afore-mentioned problems, since it nevertheless is capable of only generating a single operating point.

Whilst such systems provide an informed and directed control of the well system, control of the oil and gas system based on the obtained operating point appears not to be satisfactory.

### SUMMARY OF THE INVENTION

In accordance with aspects of the present invention, there is provided a method, system and computer software according to the appended claims.

More specifically, according to a first aspect of the present invention there is provided a computer-implemented method of identifying a plurality of operating points for an oil and/or gas producing system, the oil and/or gas producing system comprising a well, a flow line and riser unit and a separator unit, said well, flow line and riser unit being arranged to output fluid to said separator unit on the basis of a plurality of independent variables and the separator unit being arranged to separate liquid and gas from the fluid output thereto, wherein operation of the oil and/or gas producing system is simulated by means of a producing system model, the producing system model being arranged to generate values for a plurality of dependent variables corresponding to pressure and/or flow rates achieved by respective units of the oil and/or gas producing system under control of said independent variables, the method comprising:

generating one or more sets of values of said independent variables corresponding to one or more operating points, respectively;

performing a process in respect of said generated one or more sets of values of independent variables, the process comprising:

operating the producing system model in accordance with each set of values of independent variables so as to generate a corresponding set of values of said dependent variables;

for each set of values of dependent variables, evaluating the values of at least one of said dependent variables in accordance with a predetermined evaluation criterion, a value of the evaluation criterion being included in the set of dependent variables;

storing the evaluated set of values of dependent variables in association with the corresponding set of values of independent variables;

using the evaluated set of values of dependent variables to generate one or more further sets of values of said independent variables and applying the process to the one or more further sets of values of said independent variables; and

repeating the process for successively generated further sets of values of independent variables until a predetermined criterion has been reached;

forming an operability map using stored sets of independent variables and corresponding sets of dependent variables; and

selecting one or more potential operating points from the operability map and/or a preferred path to manoeuvre between operating points.

Knowledge of a single optimum point as provided by the above prior art optimisation method is of limited value when it comes to delivering system optimization. This is because inaccuracies and uncertainties within the model inevitably result in a deviation between the predicted and the measured behaviour of the process. With the underlying limitations of the model, the optimum point deduced from the model may not necessarily correspond to the actual optimum way of practically operating the process. Furthermore, difficulties often arise from dynamic transients, where wide fluctuations in the flow rates dictate that a safety margin is included within the operating guidelines.

The method according to the invention provides multiple operating points instead of only a single optimum point. The operating points provide information about the behaviour of the oil and/or gas producing system and permit a judicious choice of an optimum region or optimum point, taking into account inaccuracies and uncertainties of the model and safety margins. The model can also provide context for choosing a path to manoeuvre between operating points.

The independent variables used in the method represent operating degrees of freedom available to an operator of the oil and/or gas producing system, and correspond to operating parameters that can be configured by the operator. The independent variables might include flow rate of lift gas injected into a production well; the speed of the electrical submersible pump; the pressure drop across the well head valve; the well to riser routing; the pressure drop across the discharge valve at the surface; the pressure of the separator(s) and the gas discharge pressure from the train. It will be appreciated that this is an exemplary list and that the actual independent variables will vary from environment to environment, in particular whether the reservoir from which fluid is being extracted is oil or gas, and indeed the other fluids present within the reservoir in question. The separation of liquid and gas may be carried out on the basis of further independent variables.

The dependent variables represent parameters that are dependent on the independent variables, and include the objective function (a representation of the overall operating strategy of the oil and/or gas producing system), constraints (a process limitation that restricts the envelope of operation of the oil and/or gas producing system) and so-called properties of interest. The latter dependent variable is typically an attribute that may impact the operating strategy but cannot be stated with sufficient confidence or clarity to allow it to be expressed as a constraint; an example of a property of interest is process stability.

The process for generating further sets of values of independent variables may be based on one set of values of independent variables as a starting point, for example using a single-point optimization algorithm. The process may also be based on a plurality of sets of values, for examples using a genetic algorithm. The set or sets of values used as starting point may be generated randomly.

The process may optimize one or more dependent variables by varying the values of independent variables. The number of independent variables of which the value is varied may be less than all independent variables and could be as small as two. The process may optimize a single dependent variable or it may optimize more than one dependent variable.

Once the predetermined criterion has been reached, the data generation and evaluation process ends and the data that have been stored are accessible from the appropriate data storage system via a query interface. Values of the independent and dependent variables are retrieved, for example by a suitable query, and used in a mapping function to form an operability map. The operability map may map at least two said successively stored sets of values of said dependent variables against one or more of said independent variables so as to identify two or more potential operating points. This mapping of sets of values of the dependent variables against sets of the independent variables preferably involves presenting, for example in a graphical manner, the operating points in a multi-dimensional representation. In a three-dimensional representation the dependent variable is plotted against two of the independent variables and may be visualized by the use of colours or other distinguishing symbols in the two dimensional space provided by the two independent variables. Other mapping techniques, such as parallel coordinate plotting methods, can be used.

One run of the optimisation process generates a data set of operating points. This data set can be used as a master data set from which data for several representations can be obtained by suitable queries.

Embodiments of the invention therefore identify a plurality of operating points for oil and/or gas producing systems, each operating point being characterised by a set of operating parameters which can be used to control components of the actual oil and/or gas producing system. These generated operating points are preferably collectively presented in a graphical manner to an operator of the oil and/or gas producing system, who can systematically configure the components of the oil and/or gas producing system to move, in an informed manner, through a path of operating points in order to reach what appears from the generated operating point data to be an optimal operating region. The aspect of presenting multiple operating points is an improvement over known methods such as those described in WO2004/046503, which as described above perform an optimization process yielding a single “optimal” operating point and with no context regarding changes from a current operating point to a different operating point.

In instances in which the producing system model comprises data indicative of constraints associated with said operating points, the method can further comprise mapping at least one said successively stored sets of values to the constraints so as to identify one or more potential operating points. In practice this can involve depicting the constraints in the graphical representation, and thereby provides constraint-based context for the data generated by the process.

In response to a query specifying an intended increase in the objective function for the oil and/or gas producing system, the method comprises ranking the range of sets of values of said independent, variables into a number of groups according to the respective value of the objective function. Doing so allows the sensitivity of the objective function to be reviewed in terms of the set of independent variables. With knowledge of the sensitivity of the objective function to the independent variables, the operator can generate a set of process configurations that capture the majority of the benefit (that is to say, improvement in objective function) with the minimal amount of intervention to the gathering system and production facility

In another arrangement, the dataset that had previously been ranked according to a pre-specified range of values for the objective function is further filtered according to a plurality of values for a given constraint, and the method comprises identifying a plurality of potential operating points on the basis of an evaluated set of values of a dependent variable corresponding to said values of the constraint. As a result, and rather than configuring the actual components of the gathering system and production facility according to a single, overall, operating point, a series of operating points is identified, with each point corresponding to the optimal point for the specified range of the constraint. If the optimal point lies on a constraint, then a path, which points in the direction of increasing profitability but closer proximity to the constraint, is formed by connecting the points together. With knowledge of the direction of this path, the producing system can then be modified to move through the series of points in a systematic manner, with the operator able to review the response of the gathering system and production facility to each step along the path before moving to the next step along the path.

As regards the above-described process performed as part of the computer-implemented method, generation of the further plurality of sets of values of said independent variables on the basis of the evaluated values of dependent variables can involve use of a global search heuristic such as a genetic algorithm. For example, a plurality of said generated sets of values of independent variables can be selected on the basis of the evaluated values of dependent variables, and the selected generated sets of values of independent variables modified in accordance with a recombination operator, whereby to generate a further plurality of sets of values of said independent variables. Optionally, generation of the further sets of values of independent variables can involve applying a mutation operator to the selected plurality of generated sets of values of independent variables.

In one arrangement selection from the generated sets of values of independent variables comprises selecting from sets of values of independent variables generated within the same previous iteration of the process, while, in other arrangements selection from the generated sets of values of independent variables comprises selecting from sets of values of independent variables generated within different previous iterations of the process. For example, selection can be performed on the basis of respective evaluations of dependent variables corresponding to values of independent variables generated across different generations of values, and thereby enables selection of the best performing values of all independent variables generated thus far.

According to a further aspect of the present invention there is provided a configuration system comprising a suite of software components configured individually or cooperatively to provide the functionality described above. The software components can be distributed on computing terminals remote from one another or integrated within a single computing system. Furthermore, certain of the software components can be configured on computing devices within a Local Area Network (LAN), whilst others can be remote therefrom and accessible via, for example, a public network such as the Internet. In addition there is provided a computer readable medium arranged to store the software components.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing an oil and/or gas producing system comprising a gathering system and production facility which are configured under the control of embodiments of the invention;

FIG. 2a is a schematic diagram showing a distributed computer system in which embodiments of the invention operate;

FIG. 2b is a schematic flow diagram showing processing stages within which embodiments of the invention operate;

FIG. 3 is a schematic diagram showing components of a server system configured according to an embodiment of the invention;

FIG. 4 is a schematic block and flow diagram showing steps associated with a process according to an embodiment of the invention;

FIG. 5 is a schematic block diagram showing communication between the software components shown in FIG. 3 according to an embodiment of the invention;

FIG. 6 is a schematic flow diagram showing steps performed by the data generation and evaluation component of FIG. 2 according to an embodiment of the invention;

FIGS. 7a-7f are schematic graphical representations of output generated by the process of FIG. 6 for a first configuration of an oil and/or gas producing system;

FIG. 8 is a further schematic graphical representation of output generated by the process of FIG. 6;

FIG. 9 is a yet further schematic graphical representation of output generated by the process of FIG. 6, when utilised by an operator at the production facility of FIG. 1;

FIG. 10 is a schematic graphical representation of the feasible envelope of operation established in terms of the two independent variables using output generated by the process of FIG. 6 for a second configuration of an oil and/or gas producing system;

FIG. 11 is a further schematic graphical representation showing contours of the objective function against values of the two independent variables shown in FIG. 10;

FIGS. 12a-12d are yet further schematic graphical representations of values of the two independent variables shown in FIG. 10, each Figure relating to a different constraint applied to one of the independent variables;

FIG. 13 is an alternative graphical representation to FIG. 11, configured by the output engine according to embodiments of the invention so as to graphically identify specific operating points and a preferential path selected to manoeuvre between the points;

FIG. 14 is a schematic flow diagram showing steps performed by a component of the server system S1 shown in FIG. 3 in generating output according to FIGS. 10-13;

FIG. 15a is a schematic graphical representations of values of two independent variables using output generated by the process of FIG. 6 for a third configuration of an oil and/or gas producing system;

FIG. 15b is a schematic graphical representations of values of two further independent variables using output generated by the process of FIG. 6 for the third configuration of an oil and/or gas producing system; and

FIG. 15c is a schematic graphical representations of values of yet two further independent variables using output generated by the process of FIG. 6 for the third configuration of an oil and/or gas producing system.

In the accompanying Figures various parts are shown in more than one Figure; for clarity the reference numeral initially assigned to a part is used to refer to the same part in each Figure in which the part appears.

### DETAILED DESCRIPTION OF THE INVENTION

As described above, embodiments of the invention are concerned with identifying a plurality of operating points for oil and/or gas producing systems, these operating points being characterised by a set of operating parameters for components of the various systems. The configuration of a system for, and processes involved in, identifying these points will be described in detail below, but first an overview of a representative oil and/or gas producing system will be presented.

Oil and/or gas producing systems comprise a gathering system and a production facility; the gathering system is typically configured to remove hydrocarbons from a reservoir of a geological formation, and comprises a network of flow lines and risers in fluid communication with the reservoir. The production facility is configured to process fluid output comprised of liquids and/or gases from the gathering system so as to separate oil, gas and water therefrom, and typically comprises a plurality of separators, each arranged to operate at a particular pressure or ranges of pressure and comprising a plurality of stages. The various separators and stages thereof act on the fluid to remove gas, water, solids and impurities (such as sand) to as to facilitate recovery of oil (and gas) from the fluid. As used herein, the term hydrocarbon production systems shall mean and include systems which produce gas, oil, or gas and oil from geological formations.

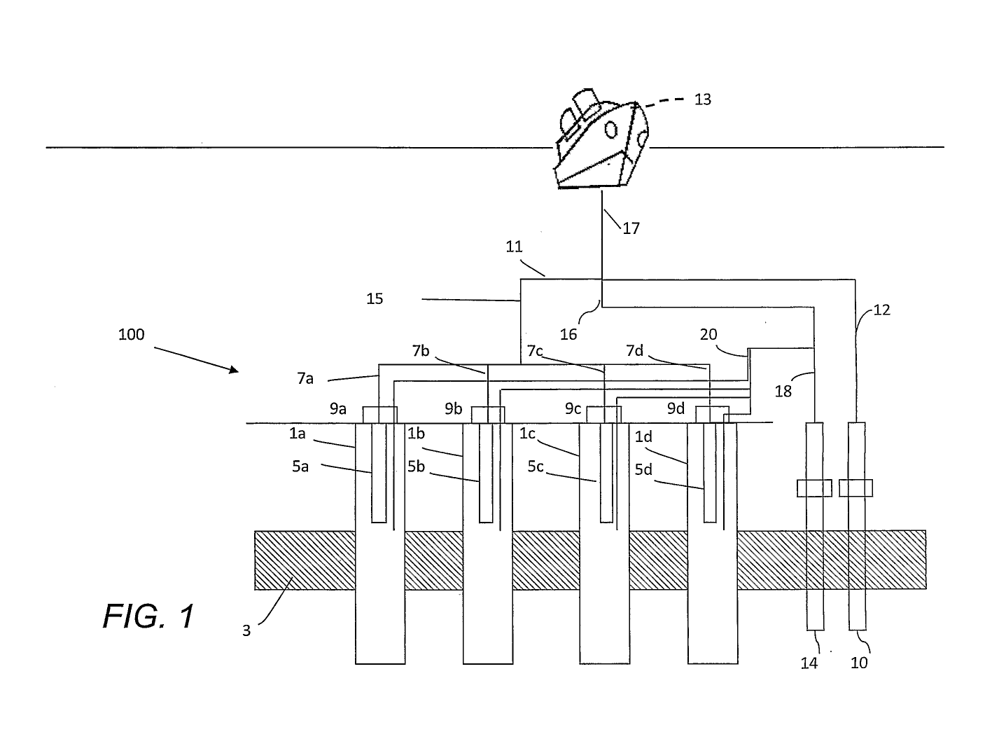

FIG. 1 is a schematic block diagram showing a simplified representation of a typical gathering system 100 for an offshore oil field. In this Figure, a plurality of production wells 1a . . . 1d is used to drain at least one formation 3 making up an oil reservoir. Each production well 1a has a production tubing 5a arranged therein and is provided with a wellhead 9a that has at least one flow control component associated therewith such as a choke valve. Accordingly, the production tubing serves to transport fluids produced from the formation 3 to the wellhead 9a. From the wellhead 9a, the produced fluids pass into flow line 7a which connects with a main flow line 11 which transfers the produced fluids to the production facility 13 via riser 17. The riser 17 is provided with at least one flow control component (e.g. turret valve, boarding valve) at its discharge end. Moreover, additional oil and/or gas producing systems (either single or multiple oil and/or gas producing systems), such as generally shown by means of part 15, may be joined to the main flow line 11. Also, valves may be provided on the flow line 7a so that the flow path or routing of the produced fluids can be changed such that the fluid can flow into a further main flow line that communicates with the production facility 13 via a further riser. The gathering system may include at least one water injection well 10, which receives pressurised water via a water injection line 12 from the production facility 13 for injection into the reservoir 3, with the water serving to maintain reservoir pressure thereby enhancing recovery of fluids from the reservoir; in addition the gathering system may include at least one gas injection well 14, which receives pressurised gas via injection lines 16, 18 from the production facility 13 and serves to push fluids out of the reservoir 3 via the production wells 1a . . . 1d. As can be seen from the Figure, the gas injection line 16 may also deliver gas into a plurality of gas lift pipes that introduce gas to the production wells 1a . . . 1d (shown collectively as pipes 20), each acting to reduce the hydrostatic pressure within a given well 1a . . . 1d. However, it is also envisaged that one or more of the production wells 1a . . . 1d may operate under natural flow or that one or more of the production wells may be provided with an electrical submersible pump that is used to raise produced fluids to the wellhead 9a . . . 9d.

The production facility 13 can conveniently be located on a platform or floating production, storage and offloading installation (FPSO), which typically houses one or more separator units (not shown), located in series with one another, and including pumps, emulsifiers, coolers, heaters, desalters, dehydrators, H₂S, natural gas liquids (NGL) and/or CO₂ absorption units etc. interspersed between the separation units, together with pipes dedicated to the removal of gas, water and solids from the produced fluid. Duplication may exist in certain parts of the processing facilities in which case each series of equipment that sits in parallel is referred to as a train. Each train may receive produced fluids from a separate riser of the gathering system and separates the produced fluid into a gas stream, oil stream, and produced water stream. The separated oil and/or gas streams can then be transported by means of oil and/or gas export pipelines (not shown) to a land-based storage tank (or a distribution system or processing facility), else will be stored in cargo tanks of the platform or FPSO. In the case of gas that is separated from the produced stream, this can be utilised by the gathering system, for example, being injected into the gas injection well 14.

In order to determine optimum settings of the various components of the oil and/or gas producing system, the system is conventionally simulated by means of one or more models, each dedicated to a specific part of the oil and/or gas producing system. For example, there can be a model associated with the reservoir, a model associated with the gathering system, and a model associated with the production facility. Alternatively, and indeed as exemplified by embodiments of the invention, there can be one model associated with the gathering system 100 (which inclusively couples the reservoir 3 with the components from the sand face to the production facility 13) and another model associated with the production facility 13. These models enable calculation of least flow rates and pressures at any point in the integrated producing system based on predefined operating characteristics of the components making up the system and specified operating conditions.

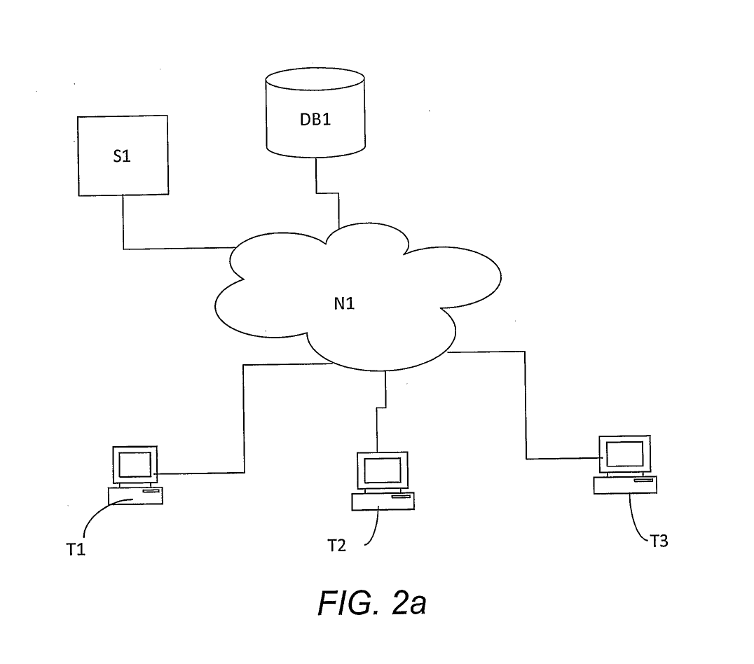

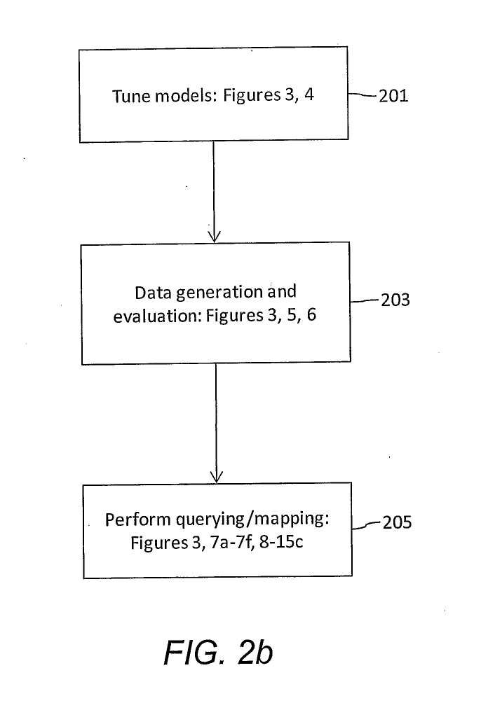

Referring to FIG. 2a, models of the gathering system 100 and the production facility can be generated in accordance with conventional techniques via user terminals T1 . . . T3; specifically, the gathering system 100 can be modelled using the proprietary software tool GAP™ developed by Petroleum Experts Ltd., for example, or other such modelling software that is commercially available or is known to one skilled in the art, and the production facility 13 can be modelled using the proprietary software tool HYSYS™ supplied by AspenTech, for example, or other such modelling software that is commercially available or is known to one skilled in the art. In an embodiment, these software modeling applications provide a toolkit, from which a user at a user terminal T1 can select and add physical information components such as particular production wells information (depth and diameters, for example), particular injection well information (depth and diameters, for example), information about the production tubing (lengths and diameters, for example) information about the wellheads, flowlines, valves, risers (lengths and diameters, for example), separator trains (one or more separators arranged in series and/or in parallel, each being arranged to reduce the pressure of fluid passing therethrough) and connections therebetween so as to define a particular implementation of a gathering system 100 and a production facility 13. Once created, sets of data representing the selected components of the modelled systems are stored in the database DB1, for subsequent execution by a server S1 during tuning and optimisation of the models, as will be described in more detail below. Typically the component data set will be transmitted from the user terminal T1 via a network, such as a corporate Local Area Network N1, or it could be transmitted over a public network involving fixed, satellite and wireless networks if the user is using a terminal remote from the server system S1 and database system DB1.

Regardless of how the model has been formed there will be a set of input values, associated with so-called independent variables and a set of output values, associated with so-called dependent variables, that have been generated from the model. An exemplary list of the independent variables is set out below:

For each production well la: flow rate of lift gas injected into the well or the speed of the electrical submersible pump; the pressure drop across the well head valve; the well to riser routing.

For each riser: The pressure drop across the discharge valve (at the surface)

For each separation train of the production facility: the pressure of the separator(s) and the gas discharge pressure from the compression train

An exemplary list of the dependent variables of the models is set out below:

Flowrates, pressures and temperature across the subsurface network;

Total production rates for the oil, gas, and water streams;

Fluid compositions across the processing facilities;

The consumption of power for the compression units; and

The superficial velocities within the subsurface network, which can be used as an indication of flow stability.

An optimisation problem can be posed by declaring an objective function along with a set of inequality and quality constraints and a range for each independent variable. An example of a typical objective function and associated constraints between the independent variables are as follows:

min(x−3)²+3y Objective function (profitability) Equation (1)

Subject to:

x−y<2 Inequality constraints

(x−2.5)²+y²>4 ″

X(0, 5) Variable bounds for x

Y(0, 5) Variable bounds for y,

where x and y denote two of the independent variables listed above. This model is used to exemplify embodiments of the invention as will become clear later in the description.

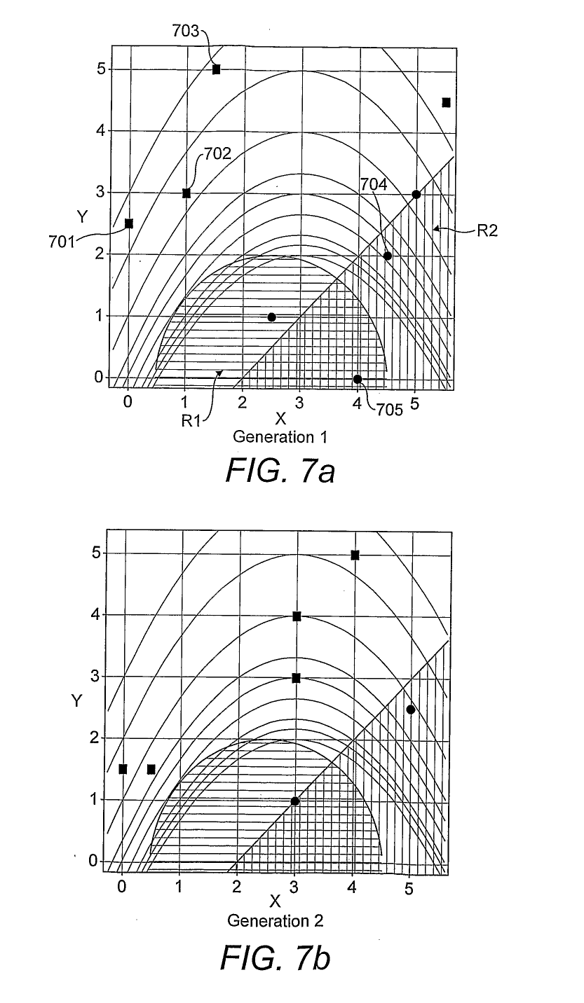

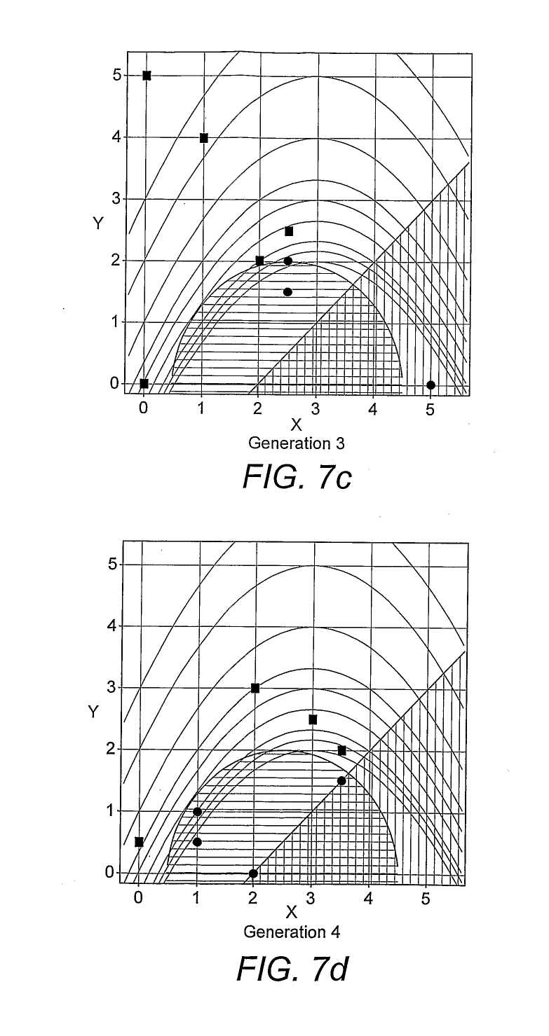

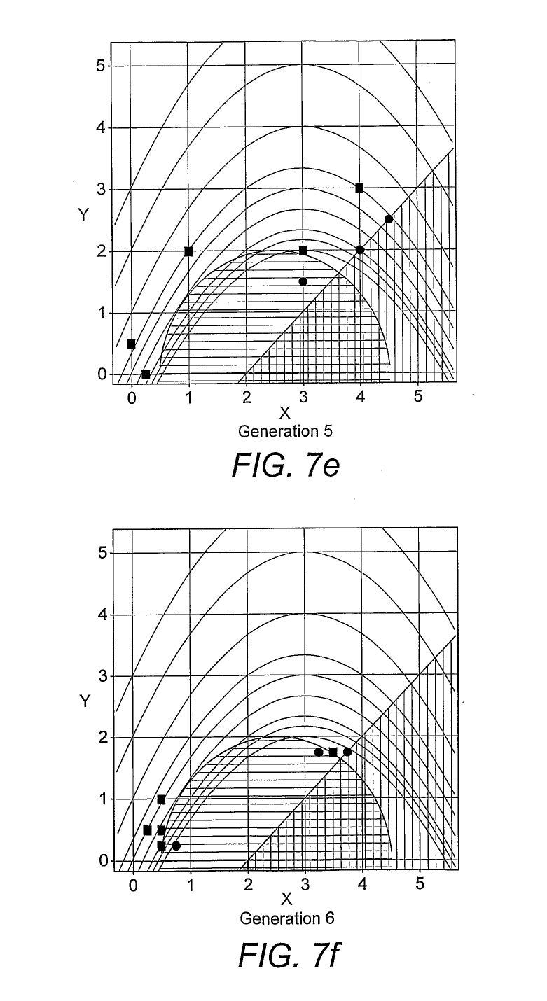

As described above, embodiments of the invention are concerned with a new optimisation and mapping process for identifying operating points for a gas and/or oil producing system; for ease of understanding embodiments will be described after a description of suitable pre-processing and configuration of the models forming the basis of the optimisation process. It is to be understood that the pre-processing steps are entirely conventional, and are included for completeness only. Accordingly, and turning to FIG. 2b, the overall process can be characterised as comprising three distinct stages: tuning of the models (201), data generation and evaluation (203) and mapping of the generated data through a query interface (205) to provide a set of operating parameters for use by an operator of a gathering system and production facility in the final stage 205 (described in more detail in FIGS. 7a . . . 7f, 8 . . . 15c).

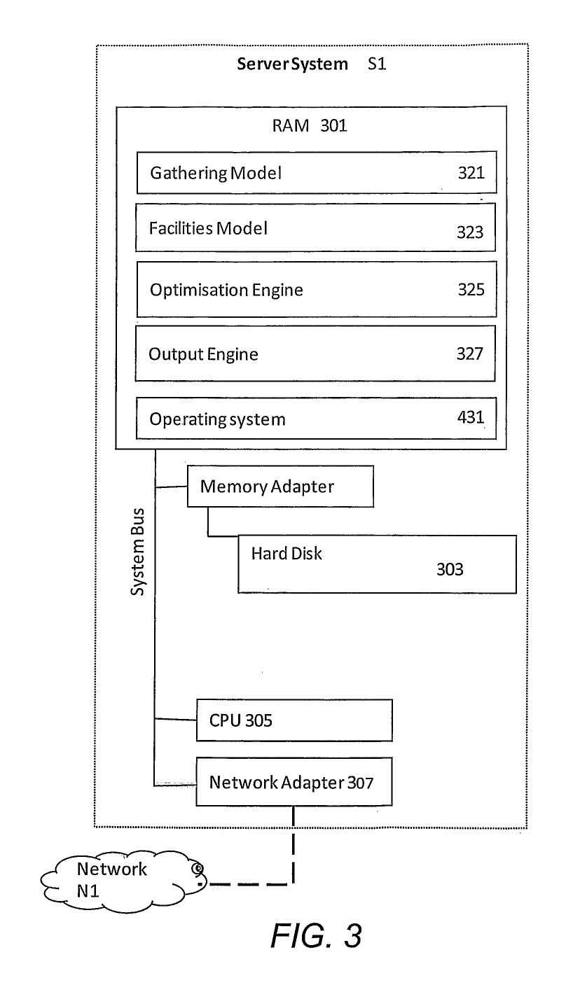

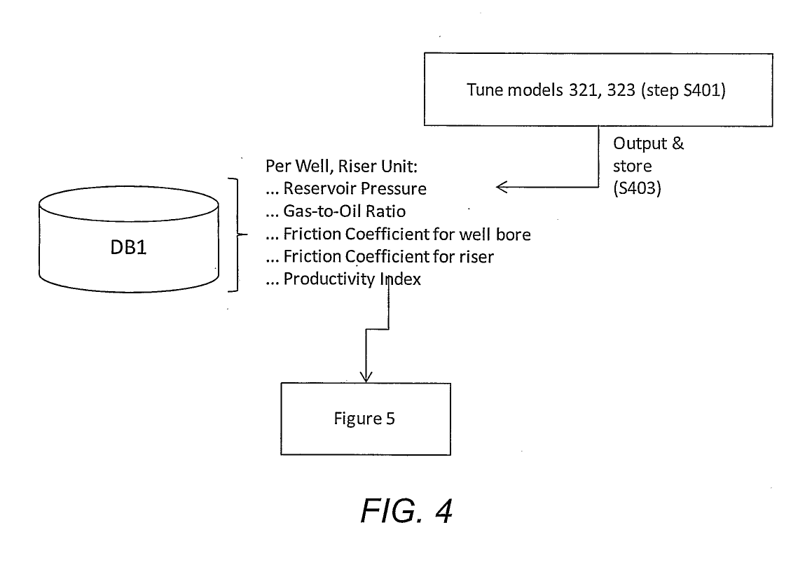

In the first stage 201 the models are tuned according to operating conditions of an actual gathering system and production facility; this involves running the models configured with a set of operating parameters (i.e., values of independent variables) and comparing the output with measured parameters of the actual gathering system and production facility; referring to FIGS. 3 and 4, the models are executed by server system S1, which comprises conventional operating system and storage components (system bus connecting the central processing unit (CPU) 305, hard disk 303, random access memory (RAM) 301, I/O and network adaptors 307 facilitating connection to user input/output devices interconnection with other devices on the network N1). The Random Access Memory (RAM) 301 contains operating system software 331 which control, in a known manner, low-level operation of the server S1. The server RAM 301 also contains the gathering system model 321 and the production facility model 323, each being configured with the component data stored in DB1 according to the user-specified models.

The purpose of the tuning process is to generate an accurate and fully representative model of the gathering system and the production facility. Within the model tuning stage 201, specific tuning parameters of components making up the models 321, 323 are automatically adjusted to maximise the fit between the model and the observed conditions of the actual gathering system and the production facility. In order to ensure that the models 321, 323 are representative over a wide range of operating conditions, the model is tuned to a data set comprising recorded process data taken at a multitude of points in time.

The models 321, 323 have, as input, values associated with so-called independent variables and generate, as output, values associated with so-called dependent variables; these variables each correspond to a measured parameter associated with the actual gathering system and the production facility. For each point in time, a set of recorded values (taken from a process data historian) for the independent variables is input to the models 321, 323. The models 321, 323 are then run and, where possible, the dependent variables calculated by the models 321, 323 are compared against the recorded values for the dependent variables taken at the same time step of the model. The absolute error is calculated for each dependent variable and the total error is used in the tuning process, per conventional model tuning techniques.

The adjustable parameters include, but are not limited to, reservoir pressure, gas to oil ratio, water cut, productivity index, friction coefficient for the well bore 1a . . . 1d and friction coefficient for each pipe (riser) 5a . . . 5d.

Once the output of the models 321, 323 is within a specified range of values of the actual dependent variables, the values of the adjustable parameters associated with this output are stored in the database system DB1 for use with embodiments of the invention (step S403). It will therefore be appreciated from the foregoing that steps S401 and S403 can be considered initialisation steps, in so far as they provide a means of configuring the models 321, 323 so as to accurately reflect operation of the physical gathering system and production facility that they are simulating.

Referring back to FIG. 2b, the next stage 203 in the overall process, namely the data generation and evaluation phase, will now be described. Referring also back to FIG. 3, in accordance with an embodiment of the invention, the server system S1 comprises a bespoke optimisation engine 331, which cooperates with data input to, and output from, the respective models 321, 323 so as to modify the behaviour of the various components making up the models. The optimisation engine 331 is preferably implemented as a genetic algorithm solver and its usage and configuration in conjunction with these known models forms a suitable tool for creating a dataset that fully characterises the operation of a given oil and/or gas producing system.

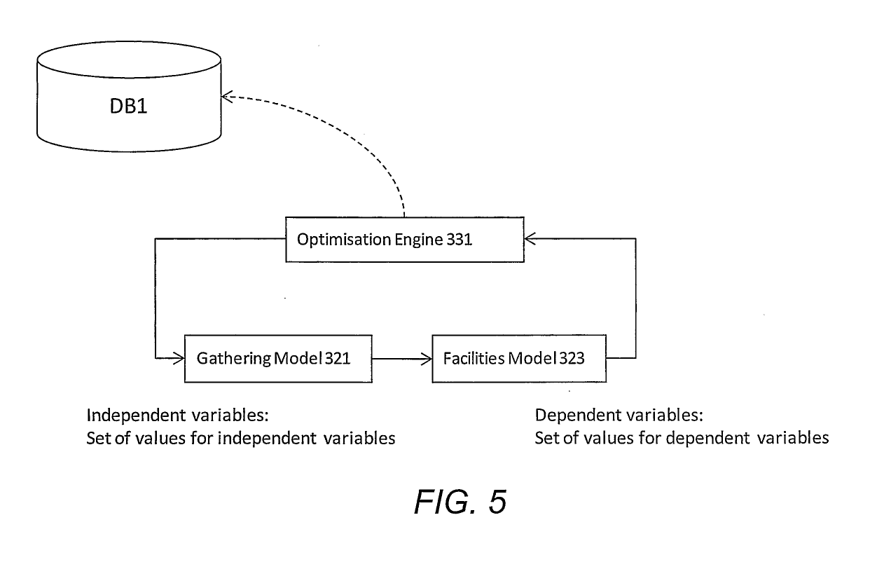

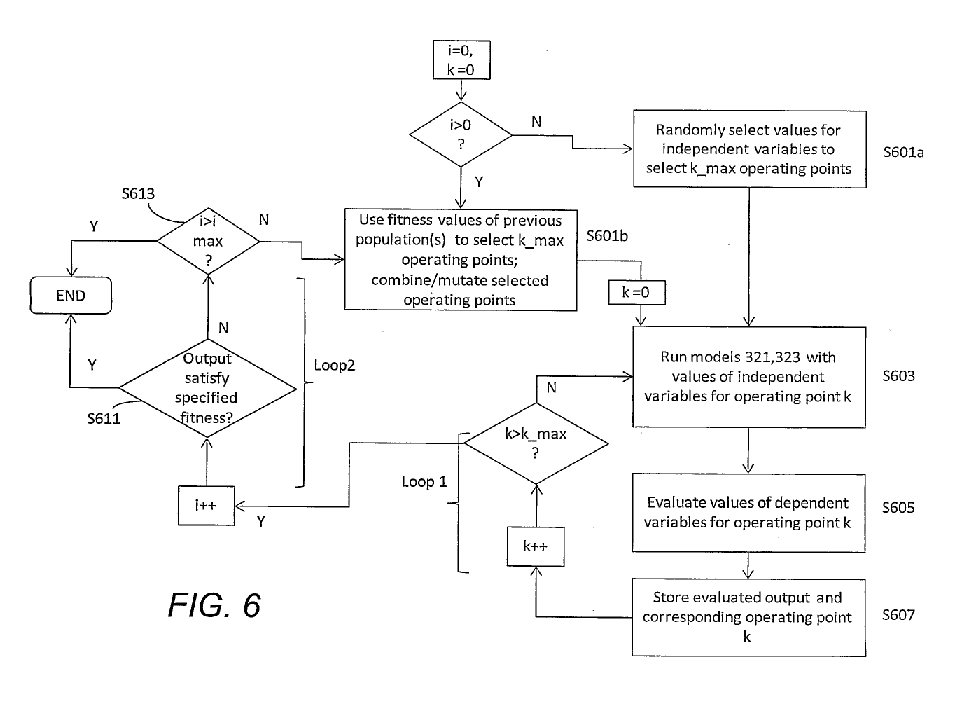

FIGS. 5 and 6 show the configuration of the optimisation engine 331 in relation to the models 321, 323 together with the steps executed by the optimisation engine 331 according to an embodiment of the invention. As briefly described above, the optimisation engine 331 is preferably embodied as a genetic algorithm, for example using the Java™ Solver SDK™ toolkit provided by Frontline Systems™, or other such software that is commercially available or is known to one skilled in the art. The optimisation engine 331 is arranged to generate a population of operating points, each corresponding to a set of values for the independent variables listed above, and, for each point in the population, to evaluate a corresponding set of output values generated by the models 321, 323. This evaluation provides a measure of the performance of the simulated oil and/or gas producing system, when operated according to the set of values for the independent variables generated by the optimisation engine 331. Moreover the optimisation engine 331 is arranged to store each operating point together with its associated dependent variable values and the evaluation thereof.

As regards the generation of a given population, the optimisation engine 331 is arranged to generate an initial population of operating points randomly, within the operating bounds of the models 321, 323 and/or according to prespecified operating bounds data. Successive generations of operating points are created on the basis of the evaluated data corresponding to previous generations of operating points and modifications thereof, these modifications being generated using combination and/or mutation operators.

This process will now be described in detail with reference to FIG. 6: at step S601a the optimisation engine 331 generates an initial population of operating points; in one embodiment of the invention, this involves randomly selecting values for the independent variables, specifically selecting, at random, as many sets of values of the independent variables as there are to be points in a given population. In the current example it is assumed that a population comprises five operating points (i.e. k_max=5) and five sets of values of the independent variables are thus selected at random.

Having selected the five operating points, each set of input values is successively input to the models 321, 323 and the models are run for each set of input values (step S603, in conjunction with loop 1). Output values corresponding to each set of input values are passed from the models 321, 323 to the optimisation engine 331, which evaluates each set of output values (S605, in conjunction with loop 1). In one arrangement this evaluation involves the optimisation engine 331 evaluating the fitness of each set of output values and evaluating whether or not the output values violate any of the model constraints. These fitness values and constraint viability, or feasibility, values are then stored in the storage system DB1 (step S607, in conjunction with loop 1) in association with a respective operating point, k.

The optimisation engine 331 then proceeds to generate a second population of operating points (step S601b, following loop 2), which in one arrangement involves selecting operating points from a previous generation of operating points on the basis of their respective evaluated fitness values, and modifying these selected points. In one arrangement the modification involves applying a recombination operator to the selected points and in another arrangement the modification involves applying a recombination operator together with a mutation operator to the selected points, in a manner that is commonly employed by genetic algorithms and is known in the art. Each member of this new population of operating points (i.e. each set of values for independent variables output from the process performed at step S601b) is then input to the models 321, 323, the models are run (step S603 in conjunction with loop 1), the corresponding values of dependent variables are evaluated, and these values are stored as described above and shown at steps S605, S607 (in conjunction with loop 1) in FIG. 6.

Once all of the operating points of the second generation have been evaluated and the corresponding data stored, the optimisation engine 331 again follows loop 2; assuming neither the evaluated fitness of the populations of operating points generated thus far satisfy a predetermined fitness criterion nor the number of generations created thus far exceeds a predetermined maximum number of generations (i_max), the optimisation engine 331 repeats steps S601b-S607, for a further generation of operating points.

The predetermined fitness criterion relates directly to the objective function set out above as Equation (1), which is a dependent variable, expressed either directly in terms of the independent variables or alternatively in terms of one or more dependent variables, which are related to the set of independent variables, so provides a convenient mechanism for controlling the data generation process. An example of the data generation and evaluation stage is shown in FIGS. 7a to 7f: the constraints (i.e., regions of inoperability) are represented by the hatched regions R1, R2, the various performance values (i.e., fitness output from the objective function set out in Equation (1)) are indicated by contours, and the operating points generated by the optimization engine 331 at step S601b are shown as squares and circles 701 . . . 705; in this example each generation comprises five operating points, and FIG. 7a is fully labeled for clarity. As can be seen, with successive generations, the location of the operating points begins to centre around two solution regions (labeled 711 and 712 in FIG. 7f).

Referring back again to FIG. 2b, the next stage 205 in the overall process, namely the mapping phase, will now be described. Referring also back to FIG. 3, in accordance with an embodiment of the invention, the server system S1 also comprises an output engine 327, which retrieves data generated by the optimisation engine 331 for output to a terminal for display thereon by means of a suitable visualisation algorithm, or to another process for manipulation thereby.

In one arrangement the output engine 327 is triggered to retrieve the generations of operating points and corresponding fitness and constraint values that were stored in the database system DB1 at step S607 (i.e. each, or a selected number of, successive iterations thereof). In one arrangement the data are output to one of the terminals T1 . . . T3 shown in FIG. 2, and received by the data visualization application running thereon. The visualization application is arranged to display the sets of operating points, preferably rendering operating points associated with a given generation in a dedicated display area. This display area corresponds to the model tuned at step S401, in particular depicting the set of constraints as a function of selected independent variables. Accordingly the set of data characterizing the model and stored at step S403 is also transmitted to the terminal to enable the visualization application to create a graphical backdrop and then display the operating points therein.

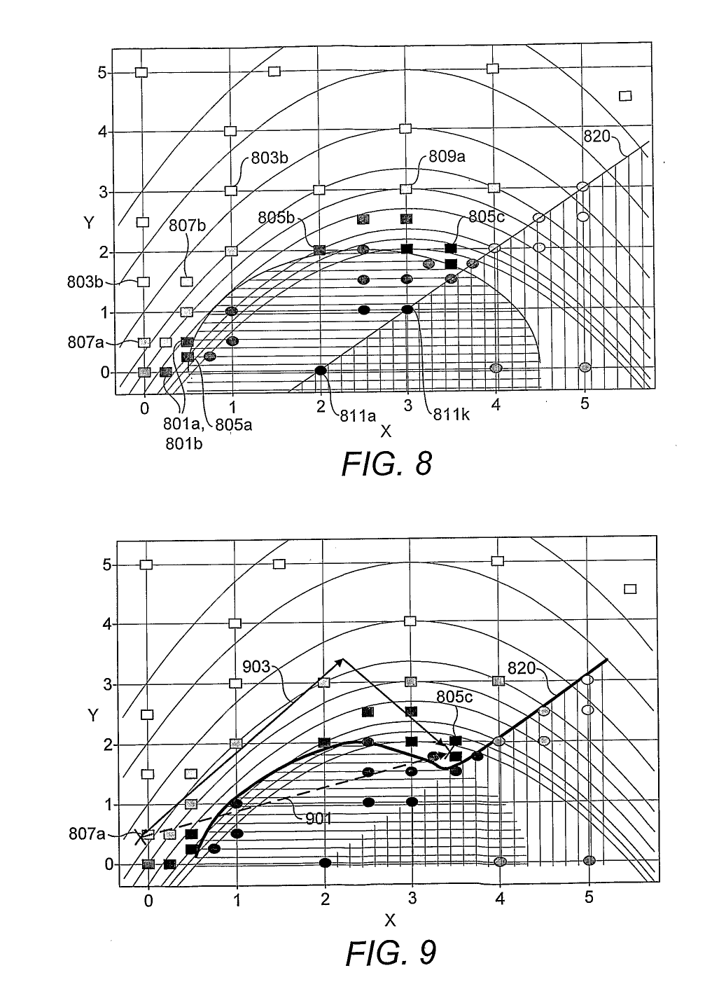

Turning to FIG. 8, most preferably all of the sets of operating points are then collectively displayed in a single display area with an indication of their fitness (i.e. how well they fare against the objective function, per Equation (1)); most conveniently this is indicated by means of different shades on the grayscale, and in the example shown in FIG. 8, the points are shaded on a sliding scale such that darker points indicate operating points with the highest fitness (e.g. point 805c) and lighter points indicate operating points with lower fitness values (e.g. point 803b). The sliding scale is being indicated via a key to the figure (only some points are labeled in the Figure for clarity). As will be appreciated from the foregoing, some of the operating points are infeasible, in the sense that they violate some of the constraints of the model (specifically the solutions that lie within the hatched regions R1, R2). Accordingly these solutions can be depicted as circles 811a . . . 811k instead of squares to indicate that they are not to be considered as viable operating points. Optionally, and as shown in FIG. 8, a curve 820 can be fitted around these infeasible operating points. In a preferred arrangement, the visualization application is invoked at a terminal in operation at the production facility 13, thereby providing an operator with a selection of possible operating points and indeed some context for making decisions as to how to move between operating points.

The aspect of presenting multiple operating points is a significant departure from known methods such as those described in WO2004/046593, which perform an optimization process yielding a single “optimal” operating point and with no context regarding changes from a current operating point to a different operating point. Indeed, as shown in FIG. 9, a particular advantage of embodiments of the invention is that operators of the oil and/or gas producing system can configure the components of the oil and/or gas producing system to move, in an informed manner, through a path of operating points in order to reach what appears to be an optimal operating region. In the context of embodiments of the invention, “an informed manner” means that the oil and/or gas producing system can be configured to move through a series of viable operating points and thereby avoid any operating points that violate the associated operating constraints (these being represented by curve 820). To illustrate this advantage, FIG. 9 shows two operating pathways from a current operating point 807a to an improved operating point 805c: a first path 901, which appears to be a direct path to a good solution 805c but which involves moving through the infeasible curve 820, and a second path 903, which comprises two parts. The second path 903 comprises two parts since it involves moving via a couple of operating points so as to avoid the infeasible region defined by the curve 820.

As described above, known methods provide an operator with a set of operating parameters that correspond to a single optimized operating point, with no context as regards how this operating point sits in relation to other possible operating points or indeed the current operating point. Thus, having been presented with an instruction to modify the producing system, the operator would modify the configuration of the components of the oil and/or gas producing system so as to move to this operating point with no information as to whether or not this would be a sensible modification given the current operating state of the producing system and indeed other possible options. Thus, and assuming the current state of the oil and/or gas producing system to correspond with operating point 807a shown in FIG. 9, this would lead the operator of the gathering system and production facility to move directly from point 807a to point 805c via the first path 901 and thereby risk failure of the entire producing system.

With embodiments of the invention, however, operators are provided with a significantly enhanced set of operating instructions, specifically performance- and constraints-based information relating to the landscape of operating points output by the data generation and evaluation engine 331. This advantageously enables the operator to move between operating points in an informed manner. Moreover, since, as observed above, models cannot simulate the exact conditions of an actual oil and/or gas producing system, they cannot predict optimal operating points with 100% accuracy (in the absolute sense). It will be appreciated that in addition to providing information as regards paths between operating points, FIG. 9 also provides an indication of how the various operating points fare relative to one another; accordingly, if the operator can extrapolate between a given simulated operating point and the current actual operating point, the extrapolation metrics can be similarly applied in relation to the operating points output by the output engine 327, thereby enabling the operator to make a realistic assessment of the actual performance of the potential operating points.

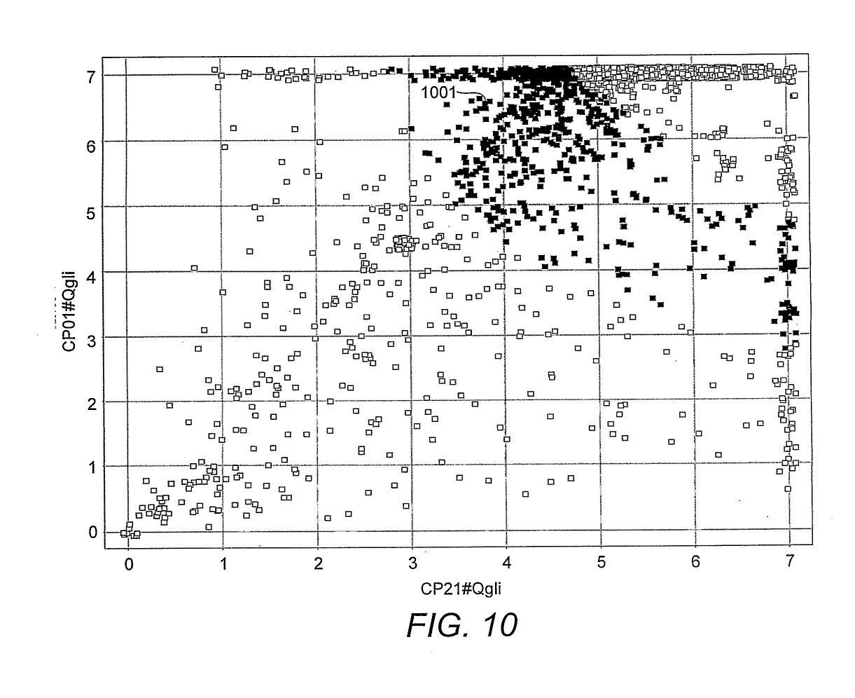

In addition to retrieving and depicting operating points, the output engine 327 is arranged to depict values of the independent variables of the model as feasible, or infeasible, operating points, instead of bounding off infeasible regions per the curve 820 shown in FIG. 8. For example, the output engine 327 could colour-code the operating points according to their status as feasible/infeasible, using the data stored in the database DB1 at step S607 of the data generation stage 203; this enables the operator to concentrate further analysis on the feasible operating regions. An example is shown in FIG. 10 for an optimisation problem comprising two variables and three constraints, representing the gas handling capacity and the minimum liquid and gas velocities that must be achieved within the riser. This model is different from the model described above and illustrated in FIGS. 7a-9 and relates to an oil producing system comprising two wells CP01, CP21 flowing into a common riser that is connected to one separation train. The two wells are gas-lifted and the gas lift rate to each well can be varied between 0 and 7 mmscfd. As regards the second constraint, a minimum liquid and gas superficial velocity must be achieved within the riser to ensure stability across the process; specifically, at velocities below the minimum constraint, the riser becomes unstable resulting in wild fluctuations in the discharge flow rate flowing from the gathering system 100 into the liquid train of the production facility 13. As regards the third constraint, the amount of gas lift that can be used to lift the two wells is restricted by the gas handling capacity of the separation train of the production facility 13.

The objective function is set to equal the total production rate of oil from the two-well system. In FIG. 10, the data points created within the data generation stage 203 are presented as a function of gas lift to the two wells CP01, CP21. The output engine 327 is configured to retrieve values of the gas lift to the two wells CP01, CP02 generated during successive iterations of step S601b and the initial data generation step S601a, and to depict the points differently based on their feasibility: in the arrangement shown in FIG. 10, all the data points that are feasible are solid whilst all the data points that are infeasible are hollow; other distinguishing depiction schemes could be used based on different shapes, RBG colours, shading, line effects or labels. The representation can thus be split into feasible and unfeasible operating regions, with region 1001 comprising feasible operating points.

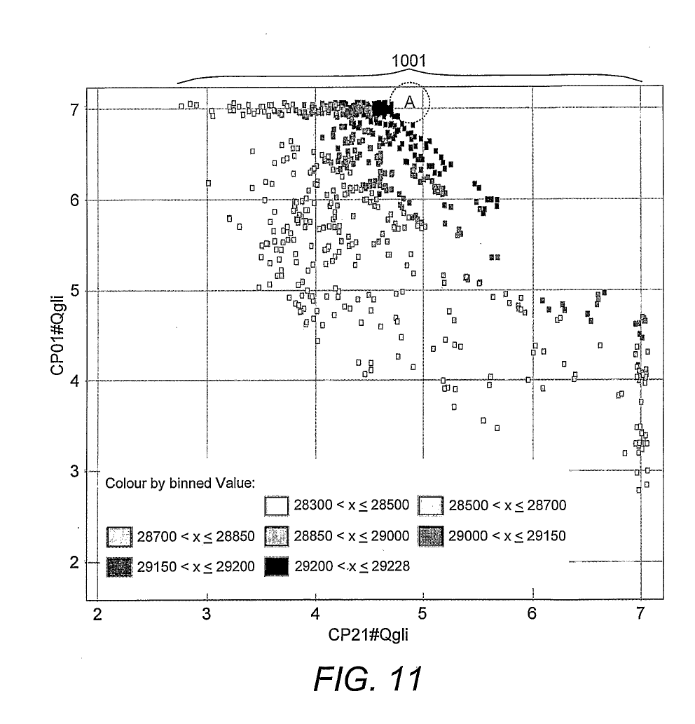

Having mapped the feasibility of the various operating points for the two independent variables and outputting the data to the visualization application running on the terminal T1, the output engine 327 can be used to generate data for use in generating a profitability map for the feasible values of the gas lift to each respective well (i.e. in relation to points lying within region 1001); this involves accessing the database DB1 in order to retrieve the fitness values for respective operating points, and sending data to the visualization application that can be used to depict each feasible operating point differently dependent on their respective fitness values. The resulting representation generated by the visualization application is shown in FIG. 11: conveniently different shades of grey can be used to show the fitness of respective operating points, but shapes, RBG colours, shading, line effects or labels could alternatively be used. The skilled person will realize that selection of an appropriate scheme will be dependent on, among other factors, the number of points that have been generated and indeed have been selected for the mapping phase (a subset of the total number of values for the independent variables generated during the data generation stage 203 and stored in the database DB1 can be selected).

Referring to the key explaining the relative performance of the various operating points, it will be appreciated that point A appears to be the preferred operating point; this point is preferably identified from a query submitted by the output engine 327 of the following form:

QUERY: <max>(objective function) gas lift_{CP01}, gas lift_{CP21}.

As described above, the gathering system and production facility do not function as stable processes; furthermore the models 321, 323—being an approximation of the actual processes—are not a wholly accurate representation thereof. Thus while point A appears, from simulation and optimisation, to be the optimum operating point, since there is a considerable amount of uncertainty both in how the processes will work in practice and how well the models 321, 323 represent the processes, point A cannot be relied on as more than an indicator of a likely preferred operating point. Thus, in one arrangement, rather than configuring the actual components of the gathering system and production facility according to the values of gas lift for the two wells CP01, CP21 corresponding to a single endpoint A, the output engine 327 generates a series of operating points, each lying along a path that heads towards the region of point A, and the producing system is modified to move through the series of points in a systematic manner; this allows the operator to review the response of the gathering system and production facility to each step along the path moving to the next step along the path.

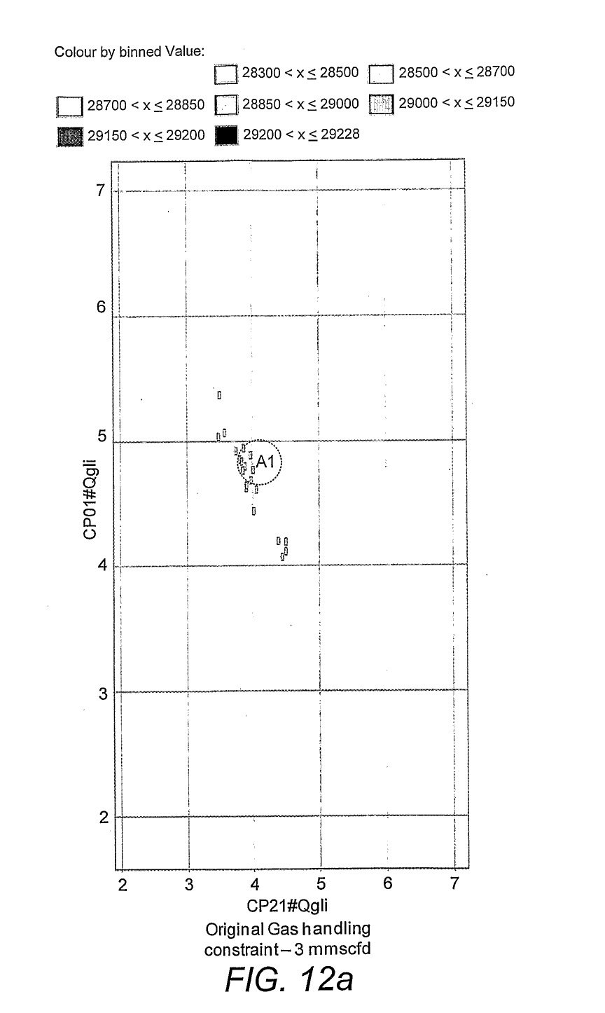

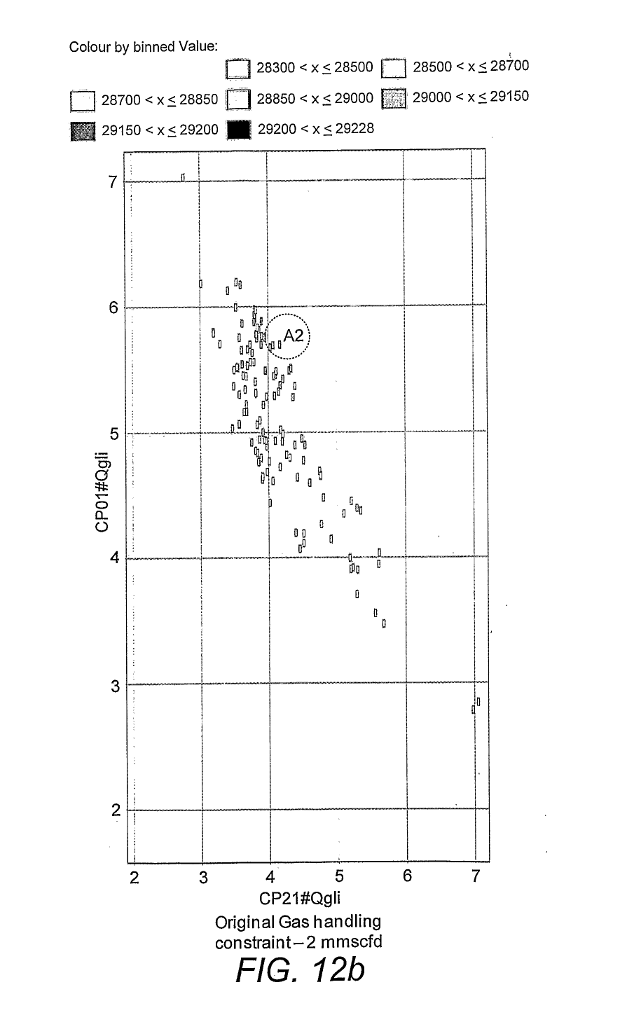

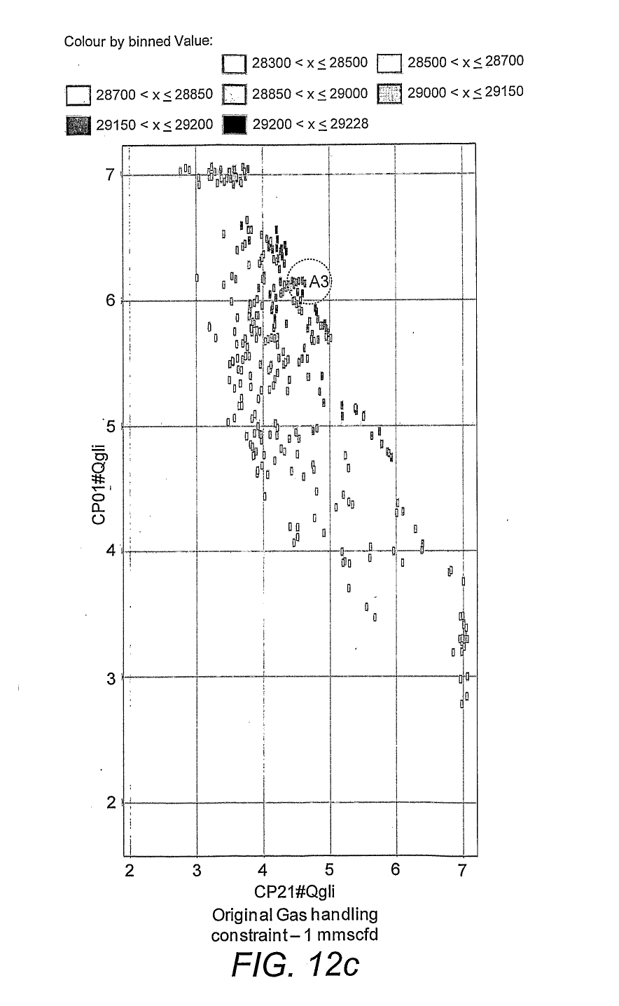

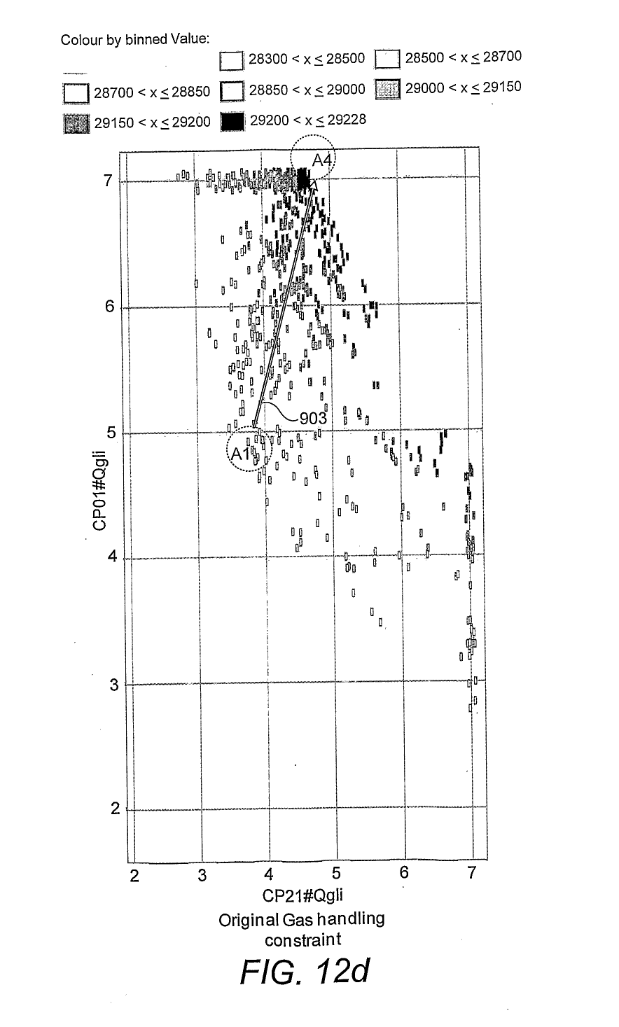

In one arrangement this path can be derived by configuring the output engine 327 to filter the optimized data stored in database DB1 and retrieve subsets of data, each relating to different constraints. Since the optimized data stored at step S607 includes the independent variables generated at steps 601a, 601b, the output engine 327 can be configured to query the database DB1 so as to retrieve just the independent variables that lie within a specified range of values. In relation to the two-variable case exemplified in FIGS. 10 and 11, FIGS. 12a-12d show a mapping generated by the output engine 327 and visualization application for four different gas-handling constraints: FIG. 12a shows the fewest number of operating points, since it relates to selection of operating points that fall within the most conservative range of the constraint (original constraint-3 mmscfd), while FIG. 12d shows the greatest number of operating points, since it relates to selection of operating points that fall within the least conservative range of the constraint (the original value of the constraint). In relation to each retrieved subset of data, a “local” optimum operating point can be identified (A1 in FIG. 12a, A2 in relation to FIG. 12b, A3 in relation to FIG. 12c and A4 in relation to FIG. 12d). The path 903 shown in FIG. 12d is a direction taken by moving, systematically, between the selected operating points A1 . . . A4.

An advantage of moving the gathering system and production facility gradually in this manner is that the process can be modified step-wise and within bounded values of the constraints through a series of local optimum points (local in the sense that each relates to a particular value of the constraint), thus enabling the operator to review how the process is actually performing as a whole in response to the change. In the event that the process reacts, or appears to react, in a manner unforeseen at one of the operating points along the path, the operator can take appropriate action; since any given operating point along the path 903 relates to an incremental change in values of the constraints, each corresponding change to the process is an incremental change in operating conditions as opposed to a significant modification thereto. Thus the process can be reviewed and remedial action taken before incurring any significant damage to the components of the gathering system or production facility.

Whilst such a systematic and step-wise approach has the advantage of enabling the operator to gauge the actual response of the process to relatively small changes, this has to be balanced against difficulties associated with manoeuvring the process, since each change to the process incurs a cost in terms of time and effort associated with each re-configuration of the components.

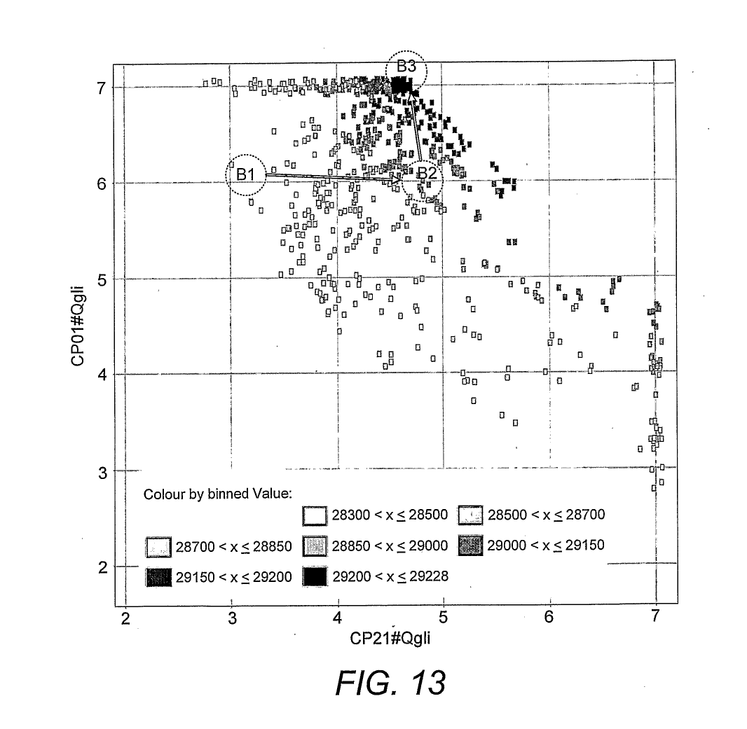

The representation of FIG. 11, in particular the representation of different fitness values of the various operating points, can be used to evaluate the merits of moving through one, two, three or four (or more depending on the particular case under consideration) different operating points along the path 903. For example, referring to FIG. 13, starting from an operating point B1, where the gas lift to well CP21 is 3.5 mmscfd, it can be seen that the objective function can be increased from 28500 to 29000 in one step (point B2) by changing the gas lift to well CP21 from 3.5 to 4.8 mmscfd and without having to modify the settings associated with gas lift well CP01 at all; further improvements in the objective function, such as would be enjoyed by moving to point B3, can be selected by modifying the gas lift to well CP01, while leaving the gas lift settings of well CP21 unchanged. It will therefore be appreciated that moving through this path of operating points B1, B2, B3 clearly has practical advantages since any given move only requires changes to be made to one well.

The output engine 327 can determine these operating points by performing the following queries on the data stored in database DB1 at step S607:

For a given initial operating point B1 for which CP21=3.5 mmscfd and CP01=6 mmscfd:

QUERY: Δ(gas lift)_{CP01}=0; Δ(gas lift)_{CP21}>0
for Δ(objective function) <min>300

QUERY: Δ(gas lift)_{CP01}>0; Δ(gas lift)_{CP21}=0
for Δ(objective function) <min>200

The visualisation application is then arranged to map the output of these queries onto the two-dimensional representation of operating points so that the operator can view the potential operating points and indeed configuration changes that are required to move from the initial operating point thereto. In one arrangement the number of returns generated based on this query is limited by specifying a maximum value for the objective function (in addition to the minimum), or by specifying a maximum number of operating points to be retrieved that satisfy the query.

The steps carried out by the output engine 327 in generating the output shown in

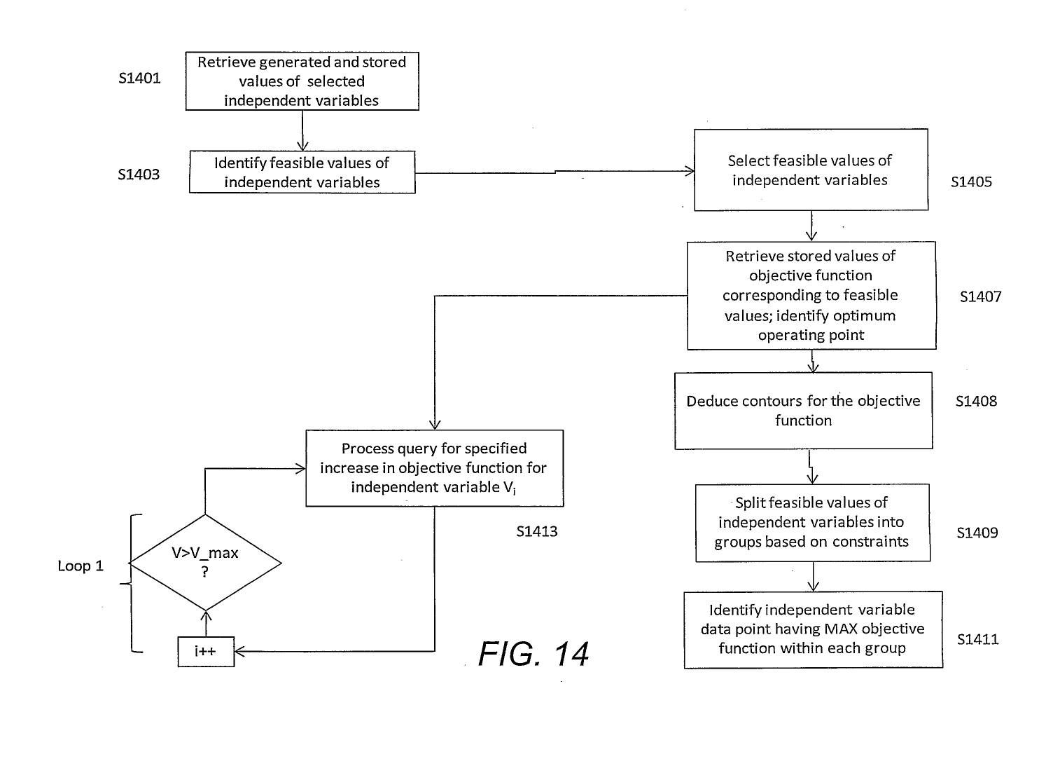

FIGS. 10-13 above are summarized schematically in FIG. 14: at step S1401, the output engine 327 accesses the database DB1 to retrieve values of selected independent variables. The model in this case comprises only two independent variables, so values for both are selected. At step S1403 the feasible values are identified, and in one arrangement the visualization application depicts feasible values differently from infeasible values, as shown in FIG. 10. At step S1405 the feasible values are selected and thereafter values of the objective function generated at step S605 of the optimization process are retrieved (step S1407). The individual data points are then rendered according to their respective performance, as shown in FIG. 11, and these values are used to generate contours for the objective function; such contours are shown in the representations of FIGS. 7a-9. The region of feasible values can be split into groups of values, for example based on several different ranges of constraints on one of the independent variables at step S1409—each of FIGS. 12a, 12b, 12c and 12d relates to a different constraint range—and the data point having the highest performance value is identified for each group (A1, A2, A3, A4). Alternatively or additionally, the output engine 327 can process queries on the performance values retrieved at step S1407, specifically to identify a data point relating to a specified increase in performance for a change in value of only one of the independent variables (step S1413). This step can be repeated for as many independent variables as were selected at step S1401 and thereby provide a series of potential changes to operating conditions that affect only one independent variable, yet result in a desired increase in performance. This is shown by points B1, B2, B3 in FIG. 13.

The aforementioned queries and mapping processes performed by the output engine 327 relate to a two-variable problem domain (since the data shown in FIGS. 10-13 relate to a gathering system and production facility comprising two wells flowing into a common riser that is connected to one separation train). In practice, the gathering system comprises far more wells and riser units (20-30 wells, for example, is not untypical), and thus far more independent variables. For such arrangements the processes performed by the optimization engine 331 and the output engine 327 involve processing, querying and retrieval of a greater set of data, and indeed mapping the retrieved data according to a commensurately greater number of dimensions. For example, a process involving 20 independent variables requires the optimization engine 331 to run for a minimum of 10 iterations, and in an embodiment may run for between 20-40 iterations (each iteration being indicated by loop 2 shown in FIG. 6 and the number of iterations is controlled by the setting of i_max), and in an embodiment generate approximately 50 operating points per population. Thus optimization according to an embodiment of the invention for such a gathering system is likely to yield of the order 2,000-3,000 data points. For each data point the stored values may include the independent variables, the objective function and the feasibility. The feasibility indicates whether a data point breaches one or more constraints.

For such models, the output engine 327 is configured to retrieve values of the respective independent variables, together with their respective fitness values, and map the retrieved values according to input mapping instructions which may, for example, by input via an interface by an operator at one of the user terminals T1. The data for the various operability maps, e.g. on a per well basis, can be selected from a single set, of data points generated in an optimization run. As a first step, the data may be filtered to remove all infeasible points. In a second step the user selects one or two independent variables to be plotted against the objective function.

The dimensionality of the problem may be reduced by fixing the independent variables that are not included within the map. To fix each variable, the user filters the data points using a limited range for each of the fixed variables. For example, consider a three dimensional problem involving independent variables x, y and z, where each variable is defined from 0 to 1. If a user wants to plot the objective function against x and y, the value of z needs to be fixed. To ensure that there are a sufficient number of data points, the user filters the data set according to a user-provided filtering range, for examples from 0.75 to 0.85 for fixing z at 0.80. The objective function gain now be mapped against x and 5 from the filtered data set. The data can be re-filtered for generating a map for another value of z.

Any gaps between filtered data points can be filled in using interpolation, for example triangle-based cubic interpolation for two dimensions or linear interpolation for one dimension. Any slight dependency of the objective function on the fixed variables may be filtered out by averaging over the filtering range.

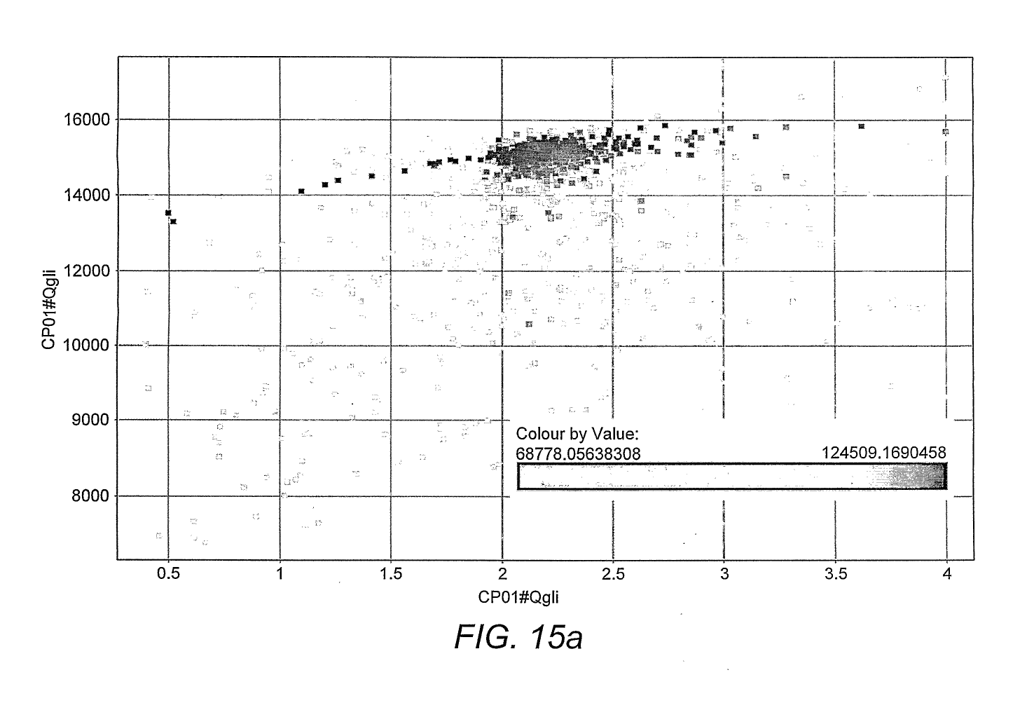

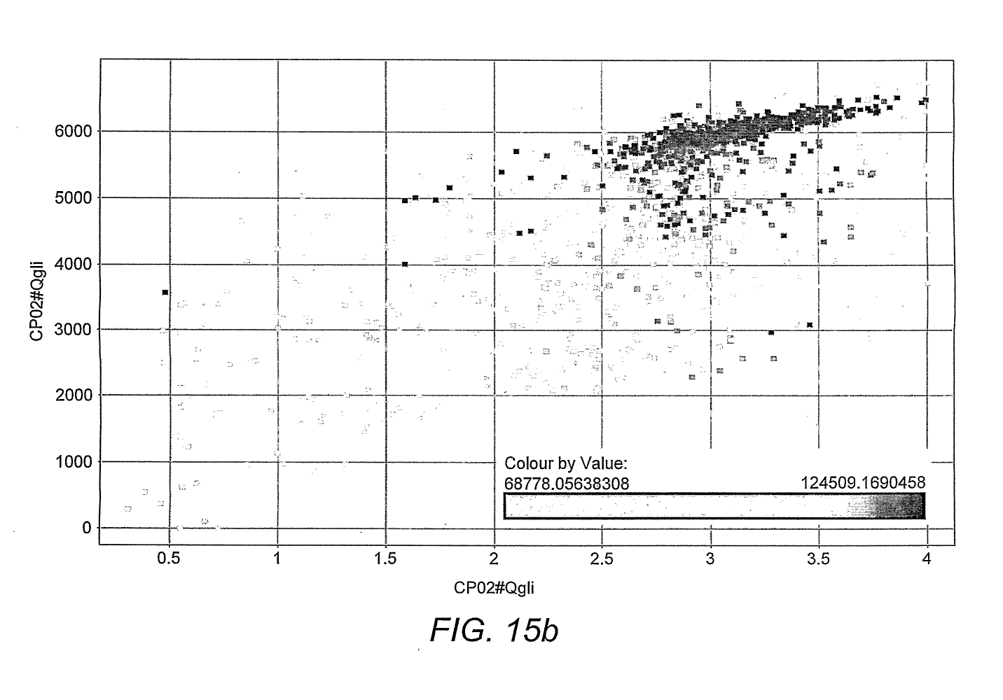

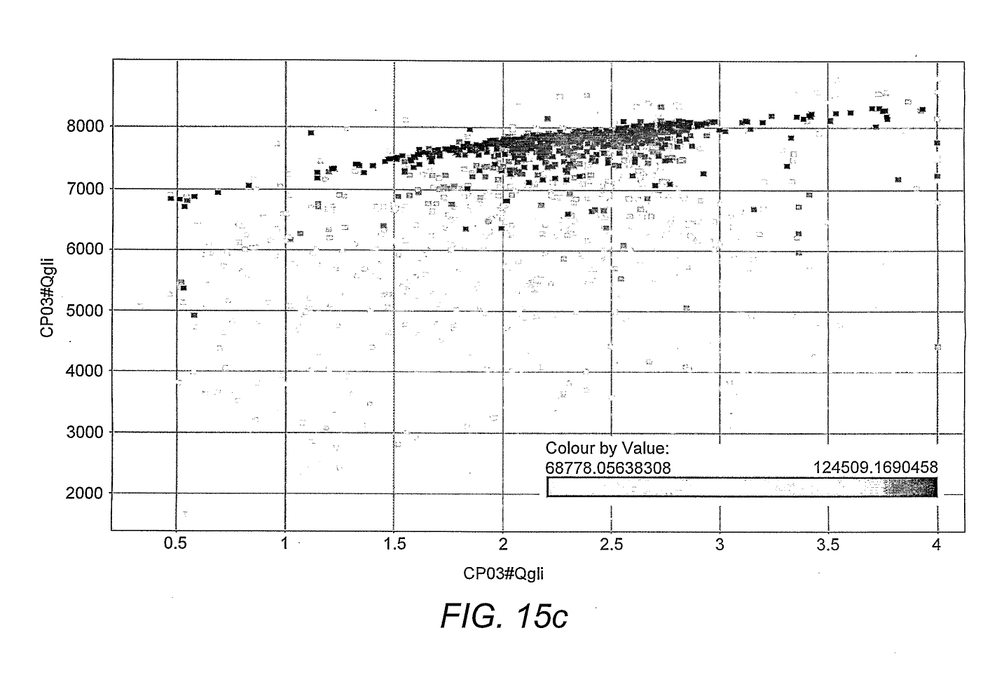

FIGS. 15a-15c show data retrieved by the output engine 327 for a gathering system and production facility that includes 22 wells flowing through a total of 9 risers that are connected to one of two liquid trains in the production facility. Each well can be gas lifted over a range of 0 to 7 mmscfd and can be re-routed to one of three risers. As described in relation to the two-variable problem, a minimum liquid and gas superficial velocity must be achieved within each riser to ensure flow stability. At velocities below this minimum constraint, the riser becomes unstable resulting in wild fluctuations in the discharge flow rate flowing from the riser into the liquid train. Due to the limitations of the compression train within the production facility, the operation of each liquid train is restricted by the gas handling capacity of the compression unit.

In this example the retrieval and mapping instructions include the following:
A) Retrieve values of the flow rate through well CP01 and gas lift through well CP01; the flow rate through well CP02 and gas lift through well CP02; and the flow rate through well WP03 and the gas lift through well WP03;
B) Retrieve the values of the objective function for each point satisfying the queries run at A);
C) Graphically identify feasible operating points for each well; and
D) Classify the data according to the objective function to create a set of contours at user-supplied intervals.

FIG. 15a shows the output generated by the output engine 327 for well CP01; FIG. 15b shows the output generated by the output engine 327 for well CP02 and FIG. 15c shows the output generated by the output engine 327 for well WP03. In each figure, every data point has been colour coded, on the grayscale, using data retrieved by the output engine 327 according to the value of the objective function for the whole system. By plotting the data in this way it is possible to evaluate the sensitivity of the objective function to the variable set. For example, FIG. 15a, for well CP01, shows a high density of points with a gas lift rate between 2 and 2.4 mmscfd lying within 1000 barrels of the optimum operating point. On the other hand, FIG. 15c, for well WP03, shows a broad arc of points that lie within 1000 barrels of the optimum spanning from 1.25 to 3.75 mmscfd.

From these figures it can be seen that the objective function is much more sensitive to the gas lift flow rate to well CP01 than it is to the gas lift flow rate to well WP03. With knowledge of the sensitivity of the objective function to the variable set, it is possible to generate a set of process configurations that capture the majority of the benefit (that is to say, improvement in objective function) with the minimal amount of intervention to the gathering system and production facility. It is also possible to determine a route to manoeuvre the process from the current operating point to a chosen “optimal” point, which maximises the improvements in productivity at the lowest risk of tripping the process.

Other forms of multi-dimensional mapping can be used such as parallel coordinate plots, where each dimension is plotted as a vertical axis and each data point is represented as a line that intercepts each vertical axis. For example, for a plurality of wells a plurality of parallel vertical lines is set up on the horizontal axis. Along each vertical line the gas lift rate of that well is plotted on a scale between 0 and 100%. The value of the gas lift rate for each well pertaining to a particular operating point can be marked on the vertical lines. The line connecting the markings represents the particular operating point. Operating points with decreasing profitability may be indicated by different colours.

A parallel coordinate plot allows determination of the independent variable that has the biggest impact on the overall objective function and of the number of local optima. A parallel coordinate plot may be made before individual two- or three-dimensional surface plots are created for a selected number of the dimensions.

The operability maps generated through the mapping software are typically analysed by the onshore support team on either a daily or weekly basis. From the set of maps, an operating strategy is deduced that will involve a set of modifications to the way in which the process is run. In determining the set of recommendations, the sensitivity of each change is analysed in terms of both the objective function (profitability of the process) and the process constraints (likelihood of tripping the process).

Based on the relative sensitivities, the set of recommendations are ranked in order of the greatest gain subject to a satisfactory risk. The proposals are sent offshore for the operator to implement, e.g. in the form of flow rate of lift gas injected into the well or the speed of the electrical submersible pump; the pressure drop across the well head valve; the well to riser routing. According to rank, each recommendation is implemented in order. In all cases the change is made gradually over a period of 1-4 hours. After a period of 6 to 12 hours, the impact of the change is assessed in terms of both the objective function and the constraints by the onshore support team. If the recommendation has proved to be successful, the next recommendation is implemented. In the unlikely event that the recommendation was unsuccessful, the model is retuned and the process mapping step is re-run the following day.

Although some of the above embodiments describe analysis of the maps by a human operator, part of the analysis or the complete analysis of the maps may be carried out using dedicated software.

### ADDITIONAL DETAILS AND MODIFICATIONS

The visualisation application described above, whose output is exemplified in FIGS. 7a-15c and which runs on one or more of user terminals T1 . . . T3, can be implemented using proprietary software such as is provided by Tibco Inc. under product name Spotfire®, or other such software that is commercially available or is known to one skilled in the art. The output engine 327 is configured to retrieve data from the database DB1, process the results of the queries, and provide the processed results to the visualisation application as described with reference to FIGS. 7a-15c.

Whilst in the above embodiments the server system S1 is described as a single processing device it could alternatively be can comprise a distributed system of processors. Similarly, while the database system DB1 is depicted in the Figures as a single device, it could be implemented as a collection of physical storage systems.

Whilst in the above embodiments each successively generated population comprises the same number of operating points, different generations can alternatively comprise a different number of operating points.

Whilst in the above embodiments, step S601b involves selecting operating points from the previous generation of operating points, the optimisation engine 331 could alternatively select points across generations of operating points so that, for example, as regards generation of the fourth generation of operating points, the engine 331 could select operating points from a mixture of the first, second and third generations of operating points. Such a selection mechanism might be preferred in the event that the selection criteria for generating successive populations of operating points is based on fitness alone quite independently of the generation with which the operating point is associated.

Further, whilst the embodiments involve use of a genetic algorithm to generate the sets of operating points, a local search method such as simulated annealing, hill climbing, or stochastic gradient descent, collectively referred to as stochastic optimisation techniques, could alternatively be used. In such methods, individual ones of the sets of values are modified by mutation of individual solutions rather than by combination with other sets of values to generate a new set of values. The optimisation engine 331 can be arranged to generate a single operating point using one of the afore-mentioned local search techniques. This operating point corresponds to a set of values for the independent variables listed above, and, the optimisation engine is configured to evaluate a corresponding output value. This evaluation provides a measure of the performance of the simulated oil and/or gas producing system, when operated according to the set of values for the independent variables generated by the optimisation engine 331. As for the above-described embodiment the optimisation engine 331 is arranged to store the operating point together with its associated dependent variable values and the evaluation thereof. Alternatively the optimisation engine 331 can be arranged to generate and evaluate a plurality of operating points, each being generated independently of one another, on the basis of one of the afore-mentioned local search methods.

Whilst the gathering system in the above-embodiments relates to retrieval of fluid from an oil reservoir, the gathering system could alternatively relate to retrieval of fluid from a gas reservoir, in which case the gathering system also comprises a network of wells and flow lines in fluid communication with a gas reservoir located in the subterranean region and the production facility is configured so as to separate gas, gas condensate and water from the process fluid output.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-26. (canceled)

27. A computer-implemented method of identifying a plurality of operating points for an oil and/or gas producing system, the oil and/or gas producing system comprising a well, a flow line and riser unit and a separator unit, said well, flow line and riser unit being arranged to output fluid to said separator unit on the basis of a plurality of independent variables and the separator unit being arranged to separate liquid and gas from the fluid output thereto, wherein operation of the oil and/or gas producing system is simulated by means of a producing system model, the producing system model being arranged to generate values for a plurality of dependent variables corresponding to pressure and/or flow rates achieved by respective units of the oil and/or gas producing system under control of said independent variables, the method comprising:
generating one or more sets of values of said independent variables corresponding to one or more operating points, respectively;
performing a process in respect of said generated one or more sets of values of independent variables, the process comprising:
operating the producing system model in accordance with each set of values of independent variables so as to generate a corresponding set of values of said dependent variables;
for each set of values of dependent variables, evaluating the values of at least one of said dependent variables in accordance with a predetermined evaluation criterion, a value of the evaluation criterion being included in the set of dependent variables;
storing the evaluated set of values of dependent variables in association with the corresponding set of values of independent variables;
using the evaluated set of values of dependent variables to generate one or more further sets of values of said independent variables and applying the process to the one or more further sets of values of said independent variables; and
repeating the process for successively generated further sets of values of independent variables until a predetermined criterion has been reached;
forming an operability map using stored sets of independent variables and corresponding sets of dependent variables; and
selecting one or more potential operating points from the operability map and/or a preferred path to manoeuvre between operating points.

28. A method according to claim 27, including a step of forming a parallel coordinate plot using stored sets of independent variables and corresponding sets of dependent variables for determining one or more potential operating points.

29. A method according to claim 27, wherein each set of values for said independent variables corresponds to a said operating point of the oil and/or gas producing system, and the method further comprises mapping at least two said successively stored sets of values of independent variables or mapping each said successively stored sets of values of selected independent variables, so as to identify one or more potential operating points.

30. A method according to claim 29, further comprising representing values of the selected independent values differently dependent on the magnitude of at least one evaluated dependent variable corresponding thereto, whereby to identify said one or more potential operating points.

31. A method according to claim 30, wherein the producing system model comprises data indicative of constraints associated with said operating points, the method further comprising mapping at least one said successively stored sets of values of the independent variables to at least one constraint so as to identify one or more potential operating points.

32. A method according to claim 31, including selecting two said independent variables and mapping the constraints data and the sets of values of the independent variables in a two-dimensional representation according to the selected two independent variables.

33. A method according to claim 31, further comprising:
for a selected said independent variable, specifying a plurality of values of a constraint relating thereto; and
for each specified constraint value, identifying a potential operating point on the basis of the evaluated set of values of dependent variables relating to the specified independent variable,
whereby to generate a set of potential operating points, each operating point in the set corresponding to a different value of the constraint.

34. A method according to claim 27, further comprising:
receiving data specifying an intended increase in performance of the oil and/or gas producing system;
for one or more selected said independent variables, identifying a range of values of said independent variables corresponding to the intended increase in performance; and
ordering the independent variables based on the identified range of values thereof so as to identify sensitivity of the independent variables to the intended increase in performance of the oil and/or gas producing system.

35. A method according to claim 33, further comprising:
receiving data specifying an intended increase in performance of the oil and/or gas producing system;
for one or more selected said independent variables, identifying a range of values of said independent variables corresponding to the intended increase in performance;
ordering the independent variables based on the identified range of values thereof so as to identify sensitivity of the independent variables to the intended increase in performance of the oil and/or gas producing system;
selecting an independent variable on the basis of the ordering; and
selectively configuring the oil and/or gas producing system according to a said generated set of potential operating points corresponding to the selected independent variable, whereby to minimise changes to the oil and/or gas producing system.

36. A method according to claim 27, comprising using a heuristic search process to generate the further plurality of sets of values of said independent variables on the basis of previously evaluated values of dependent variables.

37. A method according to claim 36, comprising selecting a plurality of said generated sets of values of independent variables on the basis of the evaluated values of dependent variables and modifying the selected generated sets of values of independent variables in accordance with a recombination operator, whereby to generate a further plurality of sets of values of said independent variables.

38. A method according to claim 36, further comprising applying a mutation operator to the selected plurality of generated sets of values of independent variables, whereby to generate the further plurality of sets of values of said independent variables.

39. A method according to claim 37, in which selection from the generated sets of values of independent variables comprises selecting from sets of values of independent variables generated by at least one previous iteration of the process.

40. A method according to claim 39, in which selection from the generated sets of values of independent variables comprises selecting from sets of values of independent variables generated within the same previous iteration of the process.

41. A gas and/or oil producing configuration system for use in identifying operating points for an oil and/or gas producing system, the oil and/or gas producing system comprising a well, a flow line and riser unit and a separator unit, said well, flow line and riser unit being arranged to output fluid to said separator unit on the basis of a plurality of independent variables and the separator unit being arranged to separate liquid and gas from the fluid output thereto, wherein operation of the oil and/or gas producing system is simulated by means of a producing system model, the producing system model being arranged to generate values for a plurality of dependent variables corresponding to pressure and/or flow rates achieved by respective units of the oil and/or gas producing system under control of said independent variables, the configuration system comprising:
a data generator arranged to generate one or more sets of values of said independent variables corresponding to one or more operating points, respectively;
a processing system arranged to perform a process in respect of said generated one or more sets of values of said independent variables, the process comprising:
operating the producing system model in accordance with each set of values of independent variables so as to generate a corresponding set of values of said dependent variables;
for each set of values of dependent variables, evaluating the values of at least one of said dependent variable in accordance with a predetermined evaluation criterion a value of the evaluation criterion being included in the set of dependent variables;
storing the evaluated set of values of dependent variables in association with the corresponding set of values of independent variables in a data storage system;
using the evaluated set of values of dependent variables to generate one or more further sets of values of said independent variables and applying the process to the one or more further sets of values of independent variables,
wherein the processing system is arranged to repeat the process for successively generated further sets of values of said independent variables until a predetermined criterion has been reached;
the configuration system further including an output engine for forming an operability map using stored sets of independent variables and corresponding sets of dependent variables.

42. A configuration system according to claim 41, wherein the configuration system further comprising mapping means arranged to map at least two said successively stored sets of values of independent variables or to map each said successively stored sets of values of selected independent variables, so as to enable identification of one or more potential operating points.

43. A configuration system according to claim 42, wherein the configuration system is operatively coupled to a visualisation software component, the visualisation software component being arranged to represent values of the selected independent values differently dependent on the magnitude of at least one evaluated dependent variable corresponding thereto, whereby to enable identification of said one or more potential operating points.

44. A configuration system according to claim 41, further comprising a query interface for receiving a query relating to a selected said independent variable,
wherein, responsive to a query specifying a plurality of values of a constraint relating to the selected independent variable, the configuration system is arranged to identify a potential operating point on the basis of the evaluated set of values of dependent variables relating to the specified independent variable,
whereby to generate a set of potential operating points, each operating point in the set corresponding to a different value of the constraint.

45. A configuration system according to claim 44, wherein, responsive to a query specifying an intended increase in performance of the oil and/or gas producing system, the configuration system is arranged to:
identify a range of values of said independent variables corresponding to the intended increase in performance; and
order the independent variables based on the identified range of values thereof so as to identify sensitivity of the independent variables to the intended increase in performance of the oil and/or gas producing system.

46. A configuration system according to claim 45 wherein the configuration system is further arranged to:
select an independent variable on the basis of the ordering; and
selectively configure the oil and/or gas producing system according to a said generated set of potential operating points corresponding to the selected independent variable, whereby to minimize changes to the oil and/or gas producing system.

47. A configuration system according to claim 41, comprising a heuristic search software component arranged to generate the further plurality of sets of values of said independent variables on the basis of previously evaluated dependent variables.

48. A configuration system according to claim 47, comprising a recombination function for use in modifying selected generated sets of values of independent variables in accordance with a recombination operator, whereby to generate a further plurality of sets of values of said independent variables.

49. A configuration system according to claim 47, further comprising a mutation operator for use in modifying selected plurality of generated sets of values of independent variables, whereby to generate the further plurality of sets of values of said independent variables.

50. A configuration system according to claim 47, wherein the configuration system is arranged to access the data storage system to select sets of values of independent variables generated by at least one previous iteration of the process.

51. A computer program, or a suite of computer programs comprising a set of instructions arranged to cause a computer, or a suite of computers, to perform the steps according to claim 27.

52. A computer readable medium comprising the computer program of claim 51.
